(19) United States
(12) Patent Application Publication
(10) Pub. No.: US 2005/0275729 A1
(43) Pub. Date: Dec. 15, 2005

(54) User interface for image processing device

(75) Inventor: Bryed Billerbeck, Mountain View, CA (US)

Correspondence Address: Townsend and Townsend and Crew LLP, Two Embarcadero Center, 8th Floor, San Francisco, CA, 94111, US

(73) Assignee: Logitech Europe S.A., Moulin du Choc (CH)

(21) Appl. No.: 10/389,425

(22) Filed: Mar. 13, 2003

(51) Int. Cl. H04N 5/228; H04N 5/225; H04N 5/76; H04N 5/14

(52) U.S. Cl. 348/222.1; 348/220.1; 348/231.99; 348/571; 725/41

(57) ABSTRACT

A method for processing image data using a portable image processing device includes forming a communication link between the portable image processing device and a remote device configured to process image data. The image processing device is associated with a first user interface. A request to a user is made whether or not the user wishes to use the first user interface to process the image data. The image data is processed using the first user interface if the user indicates that the user wishes to use the first user interface to process the image data.

### BACKGROUND OF THE INVENTION

The present invention relates to a method and apparatus for processing image data.

Digital cameras, including digital still cameras and digital video cameras, have been gaining wide acceptance among consumers recently. The digital still cameras (“DSC”) are configured to capture and store primarily still pictures or images, whereas the digital video cameras (“DVC”), e.g., camcorders, are configured to capture and store primarily moving pictures or videos. Many DSCs, however, are also configured to take videos as well as still pictures. Similarly, many DVCs also are configured to take still pictures as well as videos. Generally, the DSCs and DVCs are provided with audio recording features as well.

The digital camera is generally connected or linked to a host device to view, transfer, or edit the images captured using the camera. DSC is generally coupled to a computer for such a purpose, and DVC is generally coupled to a television system or computer for such a purpose. One example of a digital camera is disclosed in U.S. Pat. No. 6,362,851, which is assigned to the assignee of the present application, which is incorporated herein by reference.

The world is being proliferated with various consumer electronic devices, such as, personal digital assistants (“PDAs”), mobile phones, scanners, printers, digital televisions, video conference phones, and the like, that are provided with image processing capabilities. These electronic devices are generally designed for specific applications so they are configured to support only specific compression or data formats and provided with proprietary user interfaces. Even the same type of electronic devices support different data compression standards and user interfaces according to the manufacturers of the devices.

Similarly, the digital cameras are provided with their own specific data compression technologies and user interfaces. For example, the DVC commonly uses a digital video (“DV”) format or a Motion Picture Experts Group (“MPEG”) standard set by the International Organization for Standardization/International Electrotechnical Commission (ISO/IEC). Other video compression technologies are the H.261, H.262, and H.263 standards of the International Telecommunications Union, Teleconferencing Section (ITU-T), which are generally used for video conferencing. The DSC commonly uses a Joint Photographic Experts Group (JPEG) standard set by the ISO/ITU for storing images in compressed form using a discrete cosine transform and entropy coding. Alternatively, the digital cameras may be provided with proprietary compression technologies. Accordingly, the digital cameras of today are configured to display captured images with selected types of consumer electronic devices but are not compatible with many other electronic devices.

In addition, the digital cameras manufactured by different manufacturers are generally provided with different user interfaces. Therefore, a user would need to learn how to use a different user interface each time the user wishes to process the image data using a different digital camera, which can be burdensome to the user.

### BRIEF SUMMARY OF THE INVENTION

In one embodiment, a method for processing image data using a portable image processing device includes forming a communication link between the portable image processing device and a remote device configured to process image data. The image processing device is associated with a first user interface. A request to a user is made whether or not the user wishes to use the first user interface to process the image data. The image data is processed using the first user interface if the user indicates that the user wishes to use the first user interface to process the image data.

In another embodiment, a method for processing image data using a portable image processing device includes forming a communication link between the portable image processing device and a remote device configured to process image data, the image processing device being associated with a first user interface; determining whether or not a user wishes to use the first user interface to process the image data; and processing the image data using the first user interface if the user indicates that the user wishes to use the first user interface to process the image data;

In yet another embodiment a method for processing image data using a portable digital camera includes forming a communication link between the camera and a host device configured to process image data, the camera being associated with a first user interface; determining whether or not a user wishes to use the first user interface to process the image data; processing the image data using the first user interface if the user indicates that the user wishes to use the first user interface to process the image data; and processing the image data using a second user interface that is different from the first user interface if the user indicates that the user does not wish to use the first user interface to process the image data, the second user interface being associated with the host device, wherein the second user interface is prevented from being executed if the user has indicated that the user wishes to use the first user interface to process the image data.

For a further understanding of the nature and advantages of the invention, reference should be made to the following description taken in conjunction with the accompanying drawings.

### BRIEF DESCRIPTION OF THE DRAWINGS

FIG. 1 is a block diagram of a digital camera according to one embodiment of the invention.

FIG. 2 depicts a block diagram of components of a digital camera involved in capturing and storing images according to one embodiment of the invention.

FIG. 3 depicts a block diagram of components of a digital camera involved in performing an identification handshake with a host device according to one embodiment of the invention.

FIG. 4 depicts a bock diagram of components of a digital camera involved in transmitting image data to a host device according to one embodiment of the invention.

FIG. 5 depicts a digital still camera 250 configured to support a plurality of transformation technologies according to one embodiment of the present invention.

FIG. 6 illustrates a digital camera being linked to one or more remote devices to process image data using a primary or secondary user interface according to one embodiment of the present invention.

FIG. 7 illustrates a schematic block diagram of a computer system according to one embodiment of the present invention.

FIG. 8 depicts a simplified flow chart of a method of image data processing using a selected user interface according to one embodiment of the invention.

FIG. 9 depicts a simplified flow chart of a method of image data processing using a selected user interface according to another embodiment of the invention.

### DESCRIPTION OF THE SPECIFIC EMBODIMENTS

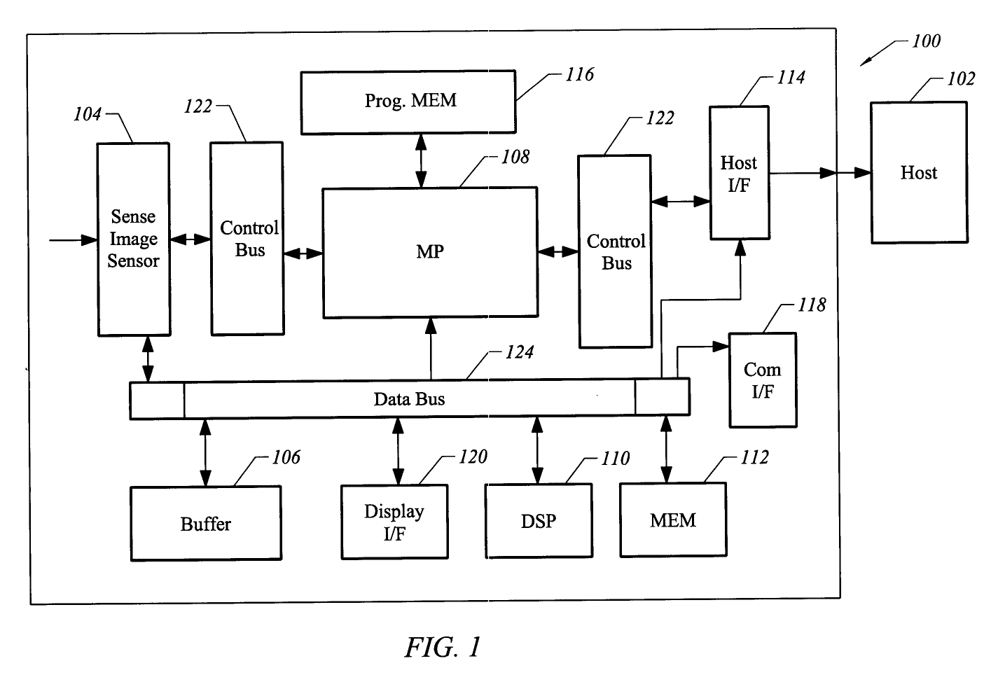

FIG. 1 depicts a digital camera 100 coupled to a host device or remote device 102 according to one embodiment of the present invention. As used herein, the term “digital camera” refers to an electronic device that captures still or moving images and converts or facilitates in converting the captured images into digital image data. The digital camera includes a portable digital still camera that is configured to capture primarily still images and a portable digital video camera, e.g., camcorder, which is configured to capture primarily moving pictures. The digital camera also may be a multi-functional portable electronic devices, such as, a portable digital assistant (“PDA”) or mobile phone with image processing capabilities. The host device 102 may be various different electronic devices, e.g., a desktop computer, laptop computer, television, optical disk apparatus, video tape player, PDA, mobile phone, digital video recorder, scanner, printer, set top box, and other devices that are configured to process image data. As used herein, the terms “host device” and “remote device” refer to an electronic device that is coupled to a digital camera for image processing purposes, and these terms are used interchangeably.

The digital camera 100 includes an image sensor 104 that receives reflected light of an object and converts it to image signals, a buffer 106 that receives the image signals from the image sensor, a microprocessor or processing system 108 that processes the image signals which includes converting the image signals to digital data, a digital signal processor (DSP) 110 that encodes or compresses the digital data to more manageable data size, a memory or storage area 112 that stores encoded data, and a host interface 114 that serves as a communication interface between the digital camera and the host device.

The digital camera 100 also includes a program memory 116, e.g., non-volatile memory, that stores various “transformation programs.” In one embodiment, the program memory is a read only memory (ROM). As used herein, the term “transformation program” refers to an encoding, decoding, decompressing, or transcoding program, or a combination thereof. For example, the transformation program includes recognized standards (e.g., JPEG, MJPEG, JPEG 200, MPEG 1, MPEG 2, MPEG 4, H.261, H.262, H.263), proprietary technologies (or non-standard programs), and the like. As used herein, the term “transformation” or “transform” used with respect to image data refers to an act relating to encoding, decoding, decompressing, transcoding, reproducing, image processing including color interpolation, scaling, defect correction, content analysis, or the like. Generally, the image data are “transformed” to facilitate displaying of encoded image data, for example, on a display area of a host device.

In addition, the digital camera 100 includes a communication interface 118 that is configured to link the digital camera with a remote computer system (e.g., a server, storage network, a personal computer, etc.) via the Internet, a local area network (LAN), a wide area network (WAN), wireless (e.g., Blutooth™, IEEE 802.11x, or cell network), or the like. In one embodiment, this communication interface 118 is also used to link to the host device. A display interface 120 enables the captured image data to be displayed on a built-in display screen (not shown) of the digital camera that is generally of small screen size. A control bus 122 couples together a plurality of the above components in the digital camera for transmitting control signals. A data bus 124 couples together a plurality of the above components in the digital camera for transmitting data. The control signals and data bus may be transmitted over the same bus or different buses according to specific application.

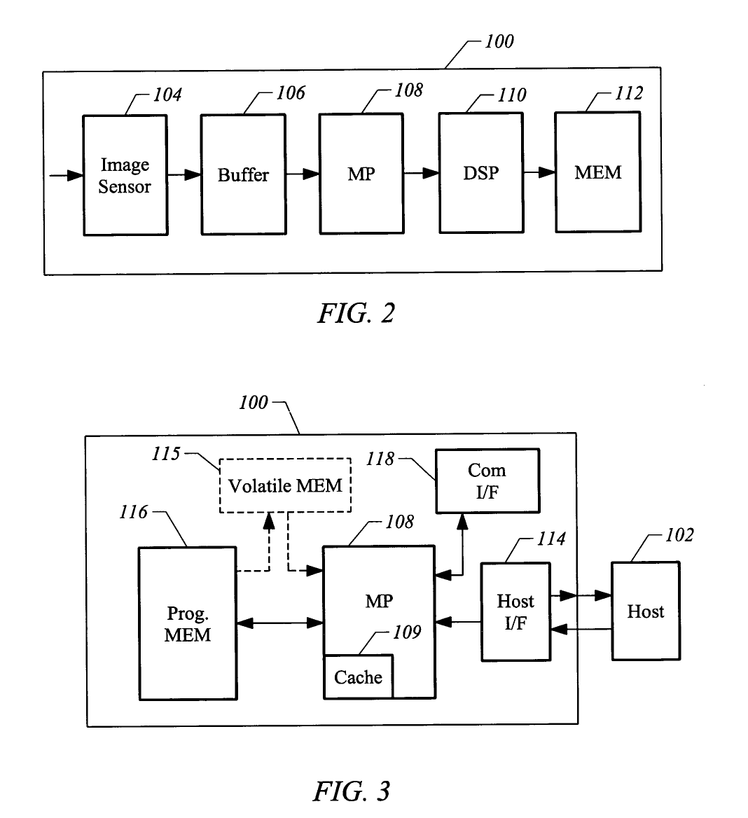

FIG. 2 depicts some of the components in the digital camera 100 that are involved in capturing and storing image data according to one embodiment of the present invention. The image sensor 104 receives reflected light of an object and converts it into electronic information representing a plurality of pixels. That is, the sensor 104 outputs image signals for an image, consisting of a plurality of horizontal lines, where each line has a plurality of pixels. The image sensor includes a mosaic color filter comprising various colors to obtain color information of the reflected light, e.g., white (W) segments, green (G) segments, cyan (Cy) segments, and yellow (Ye) segments.

The buffer 106 receives the image signal output by the sensor 104 to temporarily store it to assist the microprocessor 108 in processing the image signal. In another embodiment, the microprocessor 108 receives the image signal directly from the sensor 104 without assistance from the buffer.

The microprocessor or processing system 108 performs analog signal processing, analog-to-digital (A/D) conversion, and color digitization and processing according to the present embodiment. In the present embodiment, a single microprocessor performs all of these functions. In another embodiment, three separate dedicated components perform the above three functions, e.g., an analog signal processor, an analog-to-digital converter, and a microprocessor or digital signal processor.

The analog signal processing includes sampling, holding, and gamma correction of the image signal output by the image sensor 104, thereby outputting an image signal of a predetermined format. The A/ID conversion involves converting analog image signals resulting from the analog signal processing into digital data or image data. As used herein, the term “image data” refers to analog image information that has been converted to digital information. The color digitization and processing involves generating red color difference data R, blue difference color data B, and luminance data Y from the image data resulting from the A/D conversion process. The luminance data represent a mixture of respective color data at a predetermined ratio, e.g., a ratio of 1:2:1 for red, green and blue colors, for each pixel element. The color digitization process also includes obtaining chrominance or color difference data.

The DSP or encoder 110 encodes or compresses the processed image data output by the microprocessor according to a default format of the digital camera 100. The encoding reduces the large image data to a more manageable size. MPEG standard is commonly used encoding technology for digital cameras primarily configured to take moving picture, i.e., DVCs. On the other hand, JPEG standard is commonly used encoding technology for digital cameras primarily configured to take still pictures, i.e., DSCs.

After the image data have been encoded and reduced to a more manageable size, they are stored in the memory 112 for subsequent use. The memory 112 may be of magnetic tapes, optical disk, or transistor type (Flash memory or DRAM). In another embodiment, a single microprocessor is used to perform the functions of both the processing system 108 and the DSP 110.

FIG. 3 depicts some of the digital camera components involved in initiating transmission of image data from the digital camera 100 to the host device 102, including performing an identification handshake with the host device, according to one embodiment of the present invention. When the digital camera and the host device are first linked together, they perform an identification handshake. The handshake is used to determine whether the two devices are compatible and/or in what format the digital camera 100 should transmit the image data to the host device 102. In one embodiment, the host device transmits identification information, such as, processor type including clock speed, operating system, display type, and transformation programs (e.g., encoding and decoding technologies) supported, and the like. The host interface forwards the host identification information to the microprocessor 108.

Based on this identification information, the microprocessor determines whether the host device supports the default transformation technology of the digital camera. (The microprocessor also determines whether it or host device is better suited to transform the image data, as explained later.) If it is determined that the host device does not support the default transformation technology, the microprocessor 108 searches the program memory 116 for a transformation program that is supported by the host device. Once located, the transformation program is used to reprogram the microprocessor accordingly, so that the image data can be transformed into a format that is supported by the host device prior to transmitting the image data to the host device.

In one embodiment, the located transformation program is loaded onto an embedded memory or cache 109 in the microprocessor 109 before executing the program. The cache 109 is a high-speed volatile memory. In another embodiment, the located program is loaded onto an external high-speed volatile memory 115, e.g., DRAM, before executing the program.

If an appropriate transformation program is not located in the program memory 116, the microprocessor 108 requests the host device to transmit a suitable transformation program. The transmitted program is then used to reprogram the microprocessor 108. However, if the host device also does not have or cannot transmit an appropriate transformation program, then the microprocessor searches one or more remote computer systems via the communication interface 118 for a suitable program.

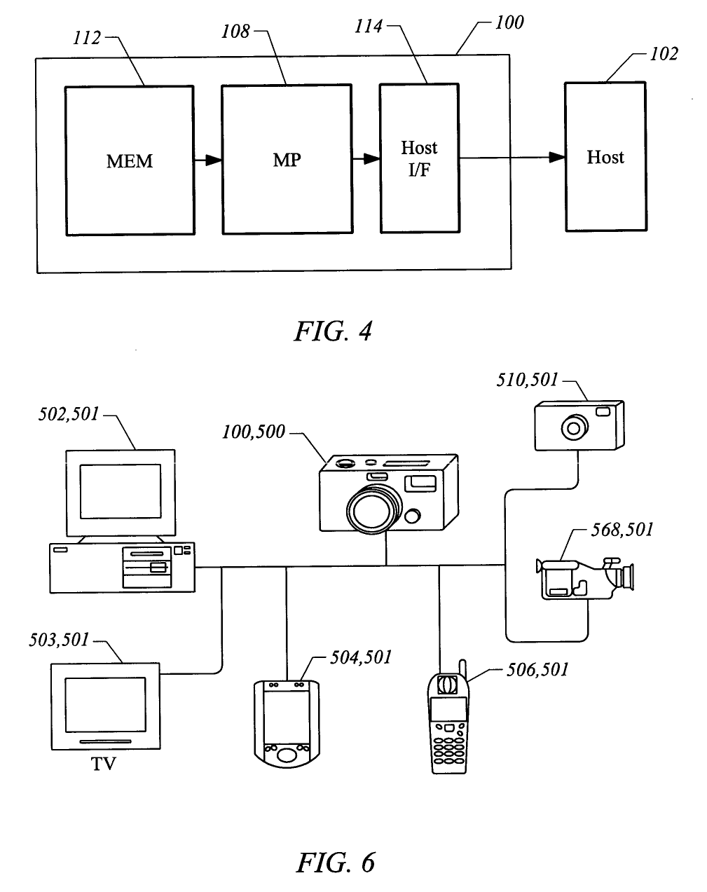

FIG. 4 depicts some of the digital camera components that are involved in transmitting image data to the host device 102 according to one embodiment of the present invention. The microprocessor 108 retrieves the encoded image data from the memory 112. The encoded image data is reproduced or transformed according to the transformation program that has been determined to be supported by the host device during the identification handshake. The transformation may involve transcoding from one technology, e.g., MPEG, to another technology, e.g. H.263. Alternatively, the transformation may involve decoding the encoded image data and then encoding them to a technology supported by the host device. The transformation also may involve a combination of transcoding, decoding, and encoding.

In one embodiment, the encoded data is transmitted without further transformation if the microprocessor determines that the host device has superior reproduction or transformation capability than the digital camera, thereby shifting the work load to more efficient device. If the host device is determined not to have an appropriate transformation program, the digital camera 100 may also transmit the transformation program to the host device along with the encoded image data. Such a transformation program may be obtained from the program memory 116 in the digital camera 100 or obtained from a remote location via the communication interface 118. In one embodiment, the transformation is shifted to the host device only if it is significantly more efficient or powerful than the digital camera.

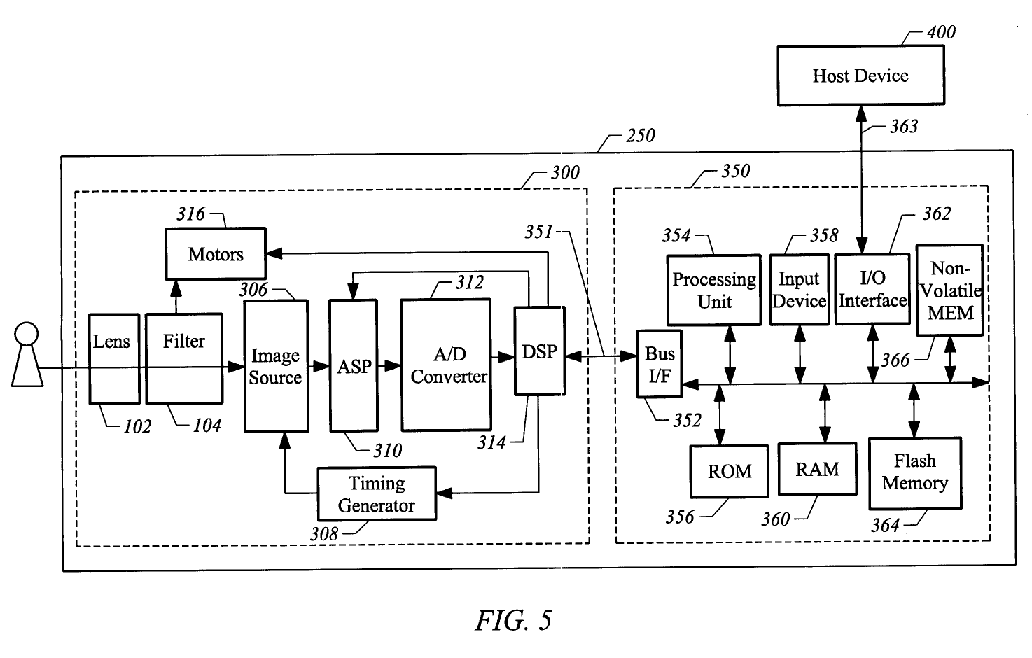

FIG. 5 depicts a digital still camera 250 configured to support a plurality of transformation technologies according to another embodiment of the present invention. The digital still camera 250 includes an imaging device 300 and a processing system 350. The imaging device includes a lens 302 having an iris, a filter 304, an image sensor 306, a timing generator 308, an analog signal processor (ASP) 310, an analog-to-digital (A/D) converter 312, a digital signal processor (DSP) 314, and one or more motors 316.

In operation, imaging device 300 captures an image of object 301 via reflected light impacting the image sensor 306 along an optical path 318. The image sensor 306 generates image signals representing the captured image. The image signals are then routed through the ASP 310, A/D converter 312 and DSP 314. The DSP 314 has outputs coupled to the timing generator 308, ASP 310, and motors 316 to control these components. The DSP 314 also has its output coupled to the processing system 350 via a bus 351. The image signals that have converted to digital image data are transmitted to system 350 and processed therein.

In one embodiment, the processing system 350 includes a bus interface 352, a processor 354, a read-only memory (ROM) 356, an input device 358, a random access memory (RAM) 360, an I/O interface 362, a flash memory 364, a non-volatile memory 366, and an internal bus 368.

The bus interface 352 is a bi-directional first-in, first-out interface for receiving the raw image data and control signals passed between the system 350 and the DSP 314. The processor 354 executes programming instructions stored in the ROM 356 and RAM 360 to perform various operations. In one embodiment, the processor 354 encodes the image data to reduce them to a more manageable size, i.e., performs the functions of the DSP 110 of the digital camera 100 (FIG. 1). The ROM 356 generally stores a set of computer readable program instructions which control how the processor 354 accesses, transforms and outputs the image data. In one implementation, the ROM 356 also stores a start-up program or file that enables a user to access the images stored in the flash memory using any computer whether it has a companion driver software installed or not.

The input device 358 generally includes one or more control buttons (not shown), which are used to input operating signals that are translated by the processor 354 into an image capture request, an operating mode selection request, and various control signals for the imaging device 300. The I/O Interface 362 is coupled to the internal bus 368 and has an external port connector (not shown) that can be used to couple digital camera 50 to a host device 400 for viewing and editing the image data stored in flash memory 364. As explained previously in connection with the digital camera 100, the image data stored in the memory 364 may be reproduced in the digital still camera 250 or at the host device 400. If reproduced in the digital still camera 250, the processor 354 reproduces the image data.

FIG. 6 illustrates a portable image processing device 500, e.g., digital camera, coupled to various different electronic devices that may serve as host or remote devices 501 according to one embodiment of the present invention. In one implementation, the image processing device 500 corresponds to the digital camera 100 or 250. The remote devices 501 may be a personal computer 502, a television 503, a personal digital assistant (“PDA”) 504, a mobile phone 506, a digital video camera or digital camcorder 508, and a digital camera 510. In one embodiment, each of these remote devices is configured to capture or process image data, or both. That is, each of the remote devices has a processor and one or more storage areas to store an operating system for processing general data and a user interface for processing image data (hereinafter, also referred to as “an intelligent remote device”). However, the remote devices 501 may be “dumb” devices, such as conventional televisions, that do not have processors nor management programs to process data.

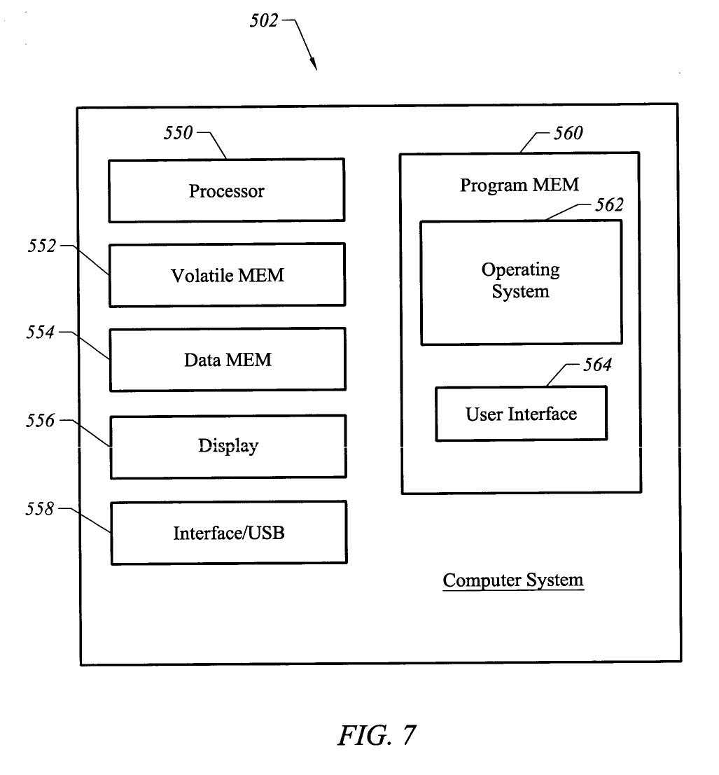

FIG. 7 illustrates a block diagram of the personal computer (or computer system) 502 according to one embodiment of the present invention. The computer 502 includes typically includes a processor 550 which communicates with a number of peripheral devices via a bus subsystem (not shown). The computer also includes a volatile memory 552, a data or non-volatile memory 554, a display 556, a remote device interface 558, e.g., a universal serial port, and a program memory 560. The program memory includes an operating system 562 and a user interface 564 for processing image data. Other intelligent remote devices have similar configurations as that described above, as understood by those skilled in the art.

The user interface 560 assists a user in processing image data. The user interface generally includes software codes to execute user inputs and physical components (or input devices) to receive user inputs. Accordingly, as used herein, the term “user interface” refers a computer program or an input device, or both, unless the context clearly indicates that the term refers solely to the program or input device.

A common user interface is a graphic user interface. Although the graphic user interface (“GUI”) provides a user with relatively easy means of processing or managing image data, the user nevertheless needs to spend time to familiarize himself or herself with the GUI. Generally, different types of image processing devices have different GUIs so the user would need to learn how to use a different GUI each time he or she is using a different device. For example, if a user wants to process image data captured using the digital camera 500 on the computer 502, the user needs to learn how to use the user interface that is supported by the computer since it is likely to be different from the user interface supported by the digital camera. This can be a burdensome task for the user, particularly since the user would have to learn yet another user interface if he or she wants to process image data on another image processing device, e.g., mobile phone.

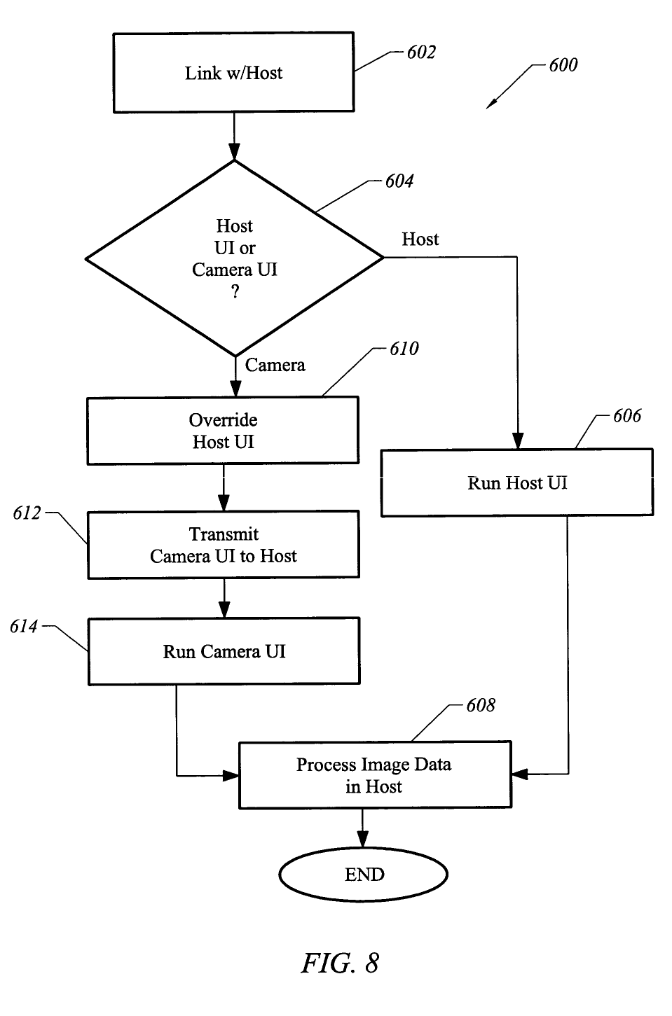

FIG. 8 illustrates a process 600 for processing image data according to one embodiment of the present invention. The digital camera 500 is coupled to a host or remote device, e.g., the computer 502, which has image data to be processed (step 602). The link between the computer 502 and the digital camera 500 may be a physical link or wireless connection. Upon making the link, the user is asked whether he or she wishes to use the computer user interface or the camera user interface to process (e.g., view, print, edit, or email) the image data (step 604). In one embodiment, this prompt appears on the display of the digital camera automatically once the communication link between the camera and the computer is formed.

As used herein, the term “primary user interface” or “first user interface” refers to the user interface associated with the digital camera, and the term “secondary user interface” or “second user interface” refers to the user interface associated with the host or remote device, i.e., the computer user interface in this example.

If the user decides to use the computer user interface or secondary user interface, the computer loads its user interface (“UI”) to a high-speed memory and executes the program. (step 606). Thereafter, the image data stored in the computer is retrieved and processed using the secondary user interface (step 608).

On the other hand, if the user decides to use the camera user interface or primary user interface, the secondary user interface in the computer is prevented from executing, so that the primary user interface can be used (step 610). The primary user interface is transmitted to the computer and loaded to a high-speed memory in the computer (step 612). Thereafter, the primary user interface is executed to retrieve and process the image data (step 614). The user provides inputs or commands by using buttons, a touch screen, voice command recognition device, or other input devices associated with the digital camera. The received commands are then forwarded to the computer for execution thereof. Alternatively or additionally, the user inputs or commands may be entered using the input means associated with the computer, e.g., a mouse, keyboard, touch screen, or other input devices. In yet another embodiment, only a portion of the primary user interface that is needed for executing the commands is transmitted to the computer by the digital camera.

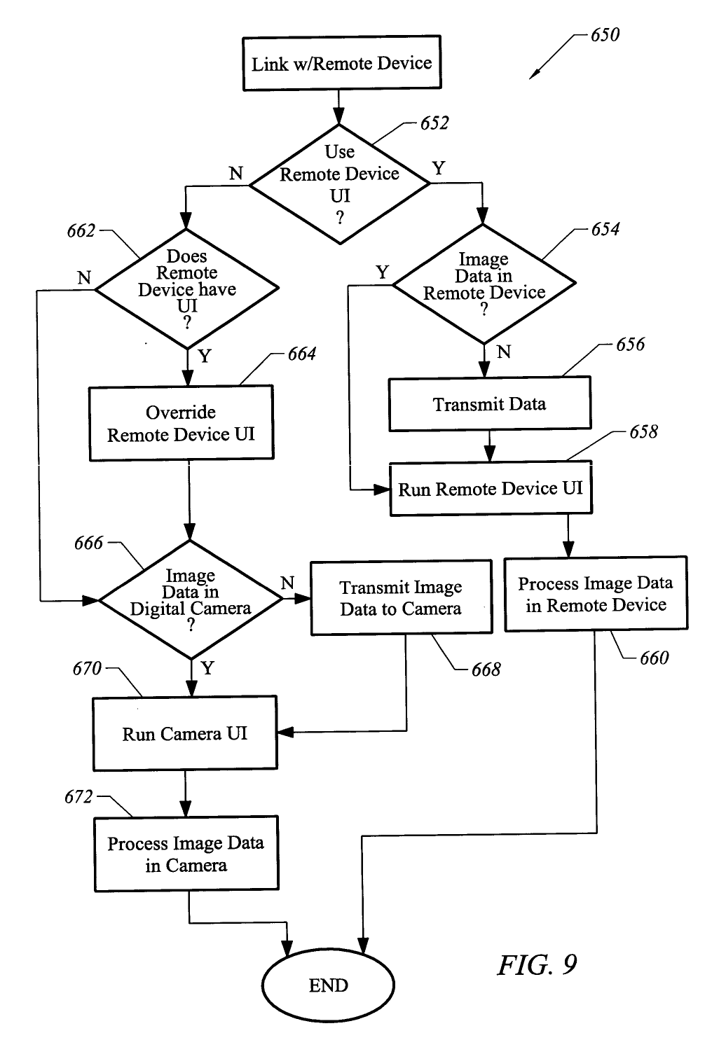

FIG. 9 illustrates a process 650 for processing image data according to another embodiment of the present invention. The digital camera 500 is linked to one of the remote devices 501. The remote device 501 that is linked with the camera 500 may be an intelligent device (e.g., a personal computer) with sophisticated image processing capabilities or a dumb device (e.g., a conventional television) with limited image processing capabilities, or a device in between.

Once the link is made or initiated, the user is asked whether he or she wishes to use the UI of the remote device 501, i.e., the secondary UI, or that of the digital camera 500, i.e., the primary UI (step 652). Generally, the user may wish to use the secondary UI or the remote device to process the image data if the remote device has greater image processing power/capabilities or has a familiar UI, or both. For example, the image processing device 500 is a portable digital still camera or mobile phone, and the remote device 501 is a personal computer having a familiar UI.

On the other hand, the user may wish to use the primary UI of the digital camera if the remote device has inferior image processing power/capabilities or less familiar UI, or both. For example, the image processing device 500 is a portable digital still camera manufactured by a first company, and the remote device 501 is a mobile phone or another portable digital still camera manufactured by a second company. If the remote device is a mobile phone, the user may prefer to use the primary UI since the portable digital still camera generally has superior image processing power and capabilities. The user may still, however, prefer to use the primary UI even if the remote device is another portable digital still camera, which has equal or superior image processing power and capabilities, if the user is unfamiliar with the UI of the latter camera and does wish to spend time to learn the secondary UI.

Referring back to the process 650, if the user chooses to use the secondary UI, it is determined whether the image data to be processed is stored in the remote device or in the digital camera (step 654). In one embodiment, the user is asked whether he or she wishes to process data stored in the digital camera or that stored in the remote device. This prompt may appear on the display area, e.g., a liquid crystal display, of the digital camera or the display area of the remote device, or both. A response to the prompt is inputted using the input device of the digital camera or remote device by the user.

If the user indicates that the image data are not stored in the remote device, the image data are accordingly transmitted from the digital camera to the remote device (step 656). In one embodiment, this step involves selecting one or more image data files stored in the digital camera subsequent to the step 654. In another embodiment, the desired image data files may be selected prior to the step 654.

The secondary UI is loaded to a high-speed memory and executed by the remote device to enable the user to commence processing the transmitted image data (step 658). In one embodiment, the remote device commence loading the secondary UI to the high-speed memory as soon as the user elects to use the secondary UI at the step 652. In another embodiment, the remote device has the secondary UI pre-loaded to its high-speed non-volatile memory, so that UI loading is not required. Thereafter, the user edits, view, or otherwise processes the image data using the secondary UI (step 660).

At step 654, if the user indicates that the image data are stored in the remote device, the process 650 proceeds to the step 658. Thereafter, the secondary UI is run and the image data are processed accordingly (steps 658 and 660).

Referring back to the step 652, if the user elects to use the UI of the digital camera, it is determined whether or not the remote device has a UI (step 662). If so, the UI of the remote device or the secondary UI is prevented from being executed (step 664). An override command is transmitted to the processor of the remote device by the digital camera, so that the executable file associated with the secondary UI is not executed by the processor of the remote device. That is, an initialization file is provided in the camera that allows appropriate applications to be launched when the camera is linked with the remote device. In one embodiment, the executable file is associated with a resident file that is running in the background, so that the resident file starts the executable file if the link between the digital camera and the remote device is formed (e.g., launching an HTML file starts a Web browser). The executable file may be embedded with scripts/applications (e.g., JavaScript™, VBA, Java™) to provide a dynamic user interface. A media format, e.g., Microsoft's ASF/WMV, which allows inclusion of data streams in the format could also be used to transfer data along with the primary stream.

At step 666, it is determined whether the image data to be processed are stored in the remote device or in the digital camera. If the image data are not stored in the digital camera, the data are transmitted from the remote device to the digital camera (step 668). The primary UI of the digital camera is run (step 670). The image data are processed using the primary UI (step 672). At step 666, if the image data to be processed are stored in the digital camera, the process proceeds directly to the step 670 to run the primary UI and process the image data.

Referring back to step 662, if the remote device does not have a UI, the process 650 proceeds directly to the step 666 since the UI override step 664 is not necessary. Generally, this is the case where the remote device is a dumb device, such as a conventional television. Thereafter, the process 650 continues on as described above to process the image data.

As will be understood by those skilled in the art, the present invention may be embodied in other specific forms without departing from the essential characteristics thereof. Accordingly, the foregoing description is intended to be illustrative, but not limiting, of the scope of the invention which is set forth in the following claims.

1. A method for processing image data using a portable image processing device, the method comprising:
forming a communication link between the portable image processing device and a remote device configured to process image data, the image processing device being associated with a first user interface;
requesting whether or not a user wishes to use the first user interface to process the image data; and
processing the image data using the first user interface if the user indicates that the user wishes to use the first user interface to process the image data.

2. The method of claim 1, further comprising:
processing the image data using a second user interface that is different from the first user interface if the user indicates that the user does not wish to use the first user interface to process the image data.

3. The method of claim 2, wherein the second user interface is associated with the remote device.

4. The method of claim 3, further comprising:
transmitting the image data from the image processing device to the remote device.

5. The method of claim 3, further comprising,
retrieving the image data from a storage area in the remote device.

6. The method of claim 1, wherein the image processing device is a portable digital camera.

7. The method of claim 6, wherein the portable digital camera is a digital still camera.

8. The method of claim 1, wherein the requesting step includes requesting whether or not the user wishes to use the first user interface to process the image data or a second user interface that is associated with the remote device to process the image data.

9. The method of claim 8, further comprising:
preventing the second user interface from being executed if the user has indicated that the user wishes to use the first user interface to process the image data.

10. The method of claim 9, further comprising:
transmitting an executable file associated with the first user interface from the image processing device to the remote device.

11. The method of claim 1, wherein the remote device is one selected from the group consisting of: a desktop computer, a laptop computer, a mobile phone, a personal digital assistant, a digital video camera, a digital still camera, a television, a scanner, and a printer.

12. The method of claim 1, wherein the image processing device and the remote device are linked via a physical communication line or wireless communication line.

13. A method for processing image data using a portable image processing device, the method comprising:
forming a communication link between the portable image processing device and a remote device configured to process image data, the image processing device being associated with a first user interface;
determining whether or not a user wishes to use the first user interface to process the image data; and
processing the image data using the first user interface if the user indicates that the user wishes to use the first user interface to process the image data.

14. The method of claim 1, further comprising:
processing the image data using a second user interface that is different from the first user interface if the user indicates that the user does not wish to use the first user interface to process the image data.

15. The method of claim 14, wherein the second user interface is associated with the remote device.

16. The method of claim 15, further comprising:
transmitting the image data from the image processing device to the remote device.

17. The method of claim 15, further comprising,
retrieving the image data from a storage area in the remote device.

18. The method of claim 13, further comprising:
preventing the second user interface from being executed if the user has indicated that the user wishes to use the first user interface to process the image data.

19. The method of claim 18, further comprising:
transmitting an executable file associated with the first user interface from the image processing device to the remote device.

20. A method for processing image data using a portable digital camera, the method comprising:
forming a communication link between the camera and a host device configured to process image data, the camera being associated with a first user interface;
determining whether or not a user wishes to use the first user interface to process the image data;
processing the image data using the first user interface if the user indicates that the user wishes to use the first user interface to process the image data; and
processing the image data using a second user interface that is different from the first user interface if the user indicates that the user does not wish to use the first user interface to process the image data, the second user interface being associated with the host device, wherein the second user interface is prevented from being executed if the user has indicated that the user wishes to use the first user interface to process the image data.
